(19) United States
(12) Patent Application Publication
(10) Pub. No.: US 2022/0066631 A1
(43) Pub. Date: Mar. 3, 2022

(54) SYSTEM AND METHOD FOR PLAYING VIDEO CONTENT

(71) Applicant: OKTEIN TECHNOLOGY LIMITED, London (GB)

(72) Inventors: George Mitchard, London (GB); Adam Istvan MERTEN, London (GB)

(73) Assignee: OKTEIN TECHNOLOGY LIMITED, London (GB)

(21) Appl. No.: 17/414,991

(22) PCT Filed: Dec. 24, 2019
(86) PCT No.: PCT/EP2019/087020

§ 371 Date: Jun. 17, 2021

Related U.S. Application Data
(60) Provisional application No. 62/784,580, filed on Dec. 24, 2018.

(51) Int. Cl. G06F 3/0488; G11B 27/00; G06F 3/0484

(52) U.S. Cl. CPC G06F 3/04883; G06F 3/0484; G11B 27/005

(57) ABSTRACT

A method of controlling playback of video content on video player on an electronic computing device, the method includes: automatically playing a video content or playing the video content when a user selects the content; detecting a user interaction on a touch-sensitive interface, wherein said user interaction comprises one or more of: a static hold interaction and/or a drag interaction; in response to said user interaction, the video player rewinding or fast-forwarding a video content; and in response to detecting cessation of the interaction, the video player starting to play back the video content at normal speed.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to playing video content, and in particular, to rewinding and fast-forwarding video content.

### BACKGROUND

Since the introduction of mobile multimedia devices, rewinding or forwarding media content has been a bad user experience. The traditional technique of scrubbing the play-head on the timeline of a media player has proven to be inaccurate due to the limited space on the display and the inaccuracy of using ones fingers. Some platforms have introduced buttons that may jump back 5, 10, or 15 seconds. Other platforms have released systems that may be triggered to jump back and forth in time when sensing a double tap gesture. However, none of these techniques provides a good user experience, especially not for sports content, as people tend to waste a lot of time trying to find the desired point within a video.

Accordingly, there is a need for a system and method to enable viewers of streaming media to control aspects of the media (e.g., rewind, fast forward, etc.) using gestures.

### SUMMARY

The present invention is specified in the claims as well as in the below description. Preferred embodiments are particularly specified in the dependent claims and the description of various embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method of controlling playback of video content on video player on an electronic computing device, the method including: playing a video content or playing the video content on a display associated with the device when a user selects the content; detecting a user interaction on a touch-sensitive interface, where said user interaction includes one or more of: a static hold interaction and/or a drag interaction; in response to detection of said user interaction, the video player rewinding or fast-forwarding a video content; and in response to detecting cessation of the user interaction, the video player playing back the video content at normal speed. Other embodiments of this aspect include corresponding computer systems, apparatus, and computer programs recorded on one or more computer storage devices, each configured to perform the actions of the methods.

Implementations may include one or more of the following features:
The method where the touch-sensitive interface is on the display and/or on the device.
The method where the touch-sensitive interface is apart from the device.
The method where the user interaction detected includes a static hold interaction on the touch-sensitive interface, the method further including: in response to detection of the static hold interaction, the video player (i) continuing to play the video content, or (ii) pausing play of the video content, or (iii) playing the video content at a slower speed.
The method where the user interaction detected includes a combined static hold interaction and drag movement interaction on the touch-sensitive interface, the method further: in response to detection of the combined static hold interaction and drag movement interaction on the touch-sensitive interface, the video player rewinding the video content.
The method where a rewind speed increases based on how far the user drags the static hold of the touch in a first direction.
The method where a rewind speed varies in response a distance of the drag movement.
The method where the rewind speed decreases as the user drags the static hold of the touch in a direction opposite the first direction.
The method where a rewind speed changes as the user drags the static hold of the touch up or down on the touch-sensitive interface.
The method where the playback pauses or returns to playback or to slower playback once the user drags the static hold back to a starting point of the static hold interaction.
The method where the playback pauses or returns to playback or slower playback once the user drags the static hold in an opposite direction.
The method where the player starts fast-forwarding the video content once the user drags the static hold in the opposite direction again.
The method where a fast-forward speed increases the further the user drags the static hold of the touch to a fast-forward direction.
The method where the fast-forward speed changes as the user drags the static hold of the touch up or down.
The method where the playback pauses again or returns to slower playback once the user drags the static hold back to a starting point of initial static hold interaction.
An article of manufacture including non-transitory computer-readable media having computer-readable instructions stored thereon, the computer-readable instructions including instructions for implementing a computer-readable method, said method operable on a device including hardware including memory and at least one processor and running a service on said hardware, said method including the above methods of controlling playback of video content.
The method where the playback pauses again or returns to playback or slower playback once the user drags the static hold in the opposite direction.
The method where the player starts rewinding the video content as the user drags the static hold in the opposite direction again.
The method where the interaction detected includes a static hold with a drag movement, where a first direction corresponds to a rewind direction and a second direction, substantially opposite said first direction, corresponds to a fast-forward direction, the method further including: in response to detection of the static hold combined with a drag movement in the fast-forward direction, the video player fast-forwarding the video content.
The method where the fast-forward speed decreases as the user drags the static hold of the touch to the opposite direction. Implementations of the described techniques may include hardware, a method or process, or computer software on a computer-accessible medium.

A skilled reader will understand, that any method described above or below and/or claimed and described as a sequence of steps or acts is not restrictive in the sense of the order of steps or acts.

Below is a list of method or process embodiments. Those will be indicated with a letter “M”. Whenever such embodiments are referred to, this will be done by referring to “M” embodiments.

M1. A method of controlling playback of video content on video player on an electronic computing device, the method comprising:

playing a video content or playing the video content on a display associated with the device when a user selects the content;

detecting a user interaction on a touch-sensitive interface, wherein the user interaction comprises one or more of: a static hold interaction and/or a drag interaction;

in response to detection of the user interaction, the video player rewinding or fast-forwarding a video content; and

in response to detecting cessation of the user interaction, the video player playing back the video content at normal speed.

M2. The method of aspect M1, wherein the touch-sensitive interface is on the display and/or on the device.

M3. The method of aspect M1, wherein the touch-sensitive interface is apart from the device.

M4. The method of any one of the preceding aspects M1-M3,

wherein the user interaction detected comprises a static hold interaction on the touch-sensitive interface,

the method further comprising:

in response to detection of the static hold interaction, the video player (i) continuing to play the video content, or (ii) pausing play of the video content, or (iii) playing the video content at a slower speed.

M5. The method of any one of the preceding aspects M1-M4,

wherein the user interaction detected comprises a combined static hold interaction and drag movement interaction on the touch-sensitive interface,

the method further comprising:

in response to detection of the combined static hold interaction and drag movement interaction on the touch-sensitive interface, the video player rewinding the video content.

M6. The method of any one of the preceding aspects M1-M5, where a rewind speed increases based on how far and/or how many times the user drags the static hold of the touch in a first direction.

M7. The method of any one of the preceding aspects M1-M6, where a rewind speed varies in response to a distance and/or number times of the drag movement.

M8. The method of any one of the preceding aspects M1-M7, where the rewind speed decreases as the user drags the static hold of the touch in a direction opposite the first direction.

M9. The method of any one of the preceding aspects M1-M8, where a rewind speed changes as the user drags the static hold of the touch up or down on the touch-sensitive interface.

M10. The method of any one of the preceding aspects M1-M9, where the playback pauses or returns to playback or to slower playback once the user drags the static hold back to a starting point of the static hold interaction.

M11. The method of any one of the preceding aspects M1-M10, where the playback pauses or returns to playback or slower playback once the user drags the static hold in an opposite direction.

M12. The method of any one of the preceding aspects M1-M11, wherein the player starts fast-forwarding the video content once the user drags the static hold in the opposite direction again.

M13. The method of any one of the preceding aspects M1-M12, where the interaction detected comprises a static hold with a drag movement,

wherein a first direction corresponds to a rewind direction and a second direction, substantially opposite the first direction, corresponds to a fast-forward direction,

the method further comprising:

in response to detection of the static hold combined with a drag movement in the fast-forward direction, the video player fast-forwarding the video content.

M14. The method of any one of the preceding aspects M1-M13, where a fast-forward speed increases the further the user drags and/or the number of times the user drags the static hold of the touch to a fast-forward direction.

M15. The method of any one of the preceding aspects M1-M14, where the fast-forward speed decreases as the user drags the static hold of the touch to the opposite direction.

M16. The method of any one of the preceding aspects M1-M15, where the fast-forward speed changes as the user drags the static hold of the touch up or down.

M17. The method of any one of the preceding aspects M1-M16, where the playback pauses again or returns to slower playback once the user drags the static hold back to a starting point of initial static hold interaction.

M18. The method of any one of the preceding aspects M1-M17, where the playback pauses again or returns to playback or slower playback once the user drags the static hold in the opposite direction.

M19. The method of any one of the preceding aspects M1-M18, where the player starts rewinding the video content as the user drags the static hold in the opposite direction again.

Below are article of manufacture embodiments. Those will be indicated with a letter “A”.

A20. An article of manufacture comprising non-transitory computer-readable media having computer-readable instructions stored thereon, the computer-readable instructions including instructions for implementing a computer-implemented method, the method operable on a device comprising hardware including memory and at least one processor and running a service on the hardware, the method comprising the method of any one of the preceding aspects M1-M19.

Below are system embodiments. Those will be indicated with a letter “S”.

S21. A system comprising:
(a) hardware including memory and at least one processor, and
(b) a service running on said hardware, wherein said service is configured to: perform the method of any one of the preceding method embodiments M1-M19.

The above features, along with additional details of the invention, are described further in the examples herein, which are intended to further illustrate the invention but are not intended to limit its scope in any way.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIGS. 1-3 show example viewing devices according to exemplary embodiments hereof;

FIGS. 4-7 show example gestures to affect aspects of a media delivery system according to exemplary embodiments hereof;

FIGS. 8A-8C are flowcharts showing exemplary operation of embodiments hereof;

FIGS. 9-11 depict example according to exemplary embodiments hereof; and

FIG. 12 shows aspects of a computing system according to exemplary embodiments hereof.

### DETAILED DESCRIPTION OF THE PRESENTLY PREFERRED EXEMPLARY EMBODIMENTS

The term “mechanism,” as used herein, refers to any device(s), process(es), service(s), or combination thereof. A mechanism may be implemented in hardware, software, firmware, using a special-purpose device, or any combination thereof A mechanism may be mechanical or electrical or a combination thereof A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

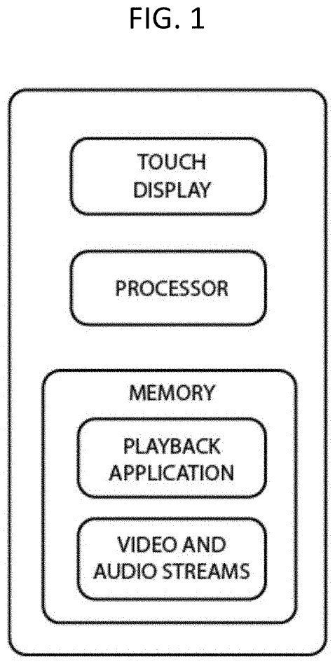

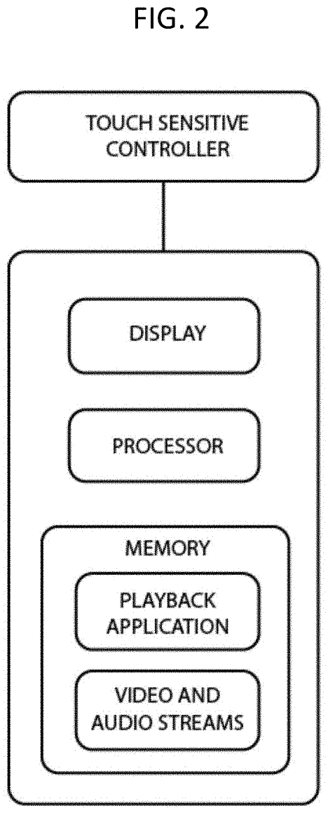

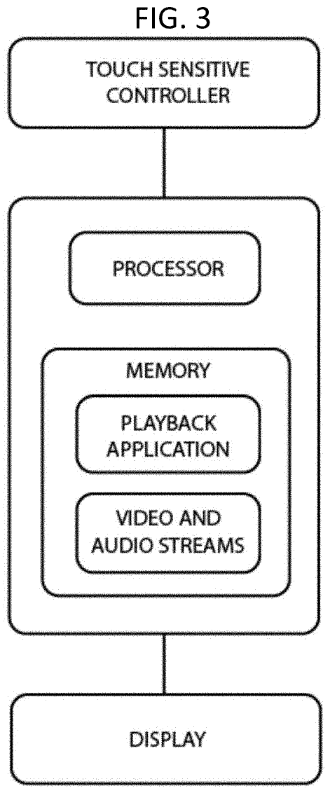

In general, the system according to exemplary embodiments hereof may provide the functionality for a viewer of streaming media to use gestures in order to rewind, fast forward, pause and/or play the media, and/or to cause the media to take any other types of actions. The system may include a backend platform (also referred to as a cloud platform) that may provide the streaming of the media. The media may be streamed from a backend platform over a network (e.g., the Internet) and viewed by viewing devices. The viewing devices may include mobile devices (e.g., smart phones, tablet computers, portable music/video devices, etc.), personal computers, laptops, smart appliances (e.g., smart televisions) or other types of viewing devices. It may be preferable that the viewing devices include touch-screens but other types of input/output interfaces or mechanisms such as a mouse, remote control(s), and other types of devices may also be used. FIGS. 1-3 show exemplary viewing devices but it is understood that other types of viewing devices may also be used.

As should be appreciated, video is preferably played in reverse when being rewound.

The system according to exemplary embodiments hereof may include a media player that may reside on the media-viewing device. The media player may also include a mobile application (“app”) or other type(s) of software or applications that may run on the viewing devices to provide at least some of the functionality of the system for viewing the streams. However, this may not be required.

For the purpose of this specification, a gesture may refer to an action taken (e.g., by the user of a media viewing device such as a mobile phone) that may be recognized by the device and that may trigger the streaming media being viewed to rewind, fast forward, pause, play or take any other action and/or any combination thereof.

In one preferred implementation, a gesture may include a particular touch interaction that the viewer may perform on the touch screen of the device. Example touch interactions may include, without limitation:

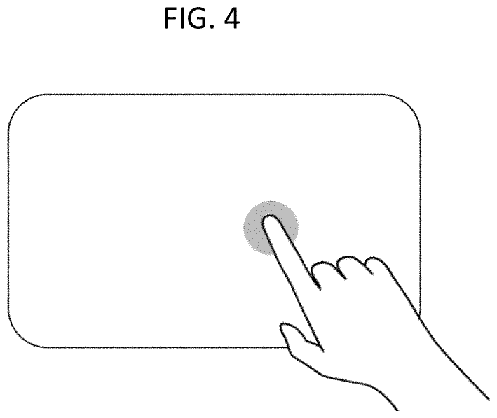

1. A static hold as shown in FIG. 4: A touch and hold interaction where the viewer touches a touch-sensitive interface (e.g., a touchscreen) and holds the touch for a duration of time;

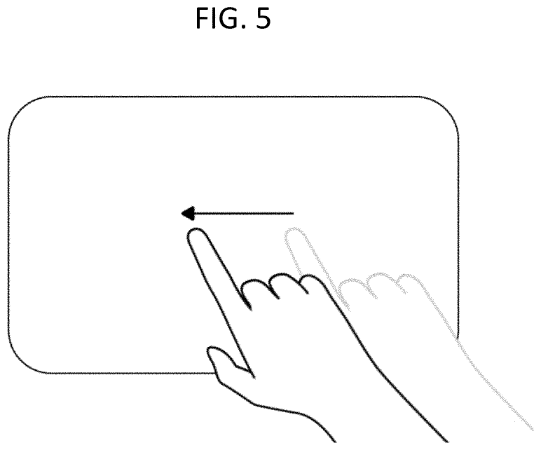

2. A swipe to the left, right, up, down or in any other direction(s) as shown in FIG. 5;

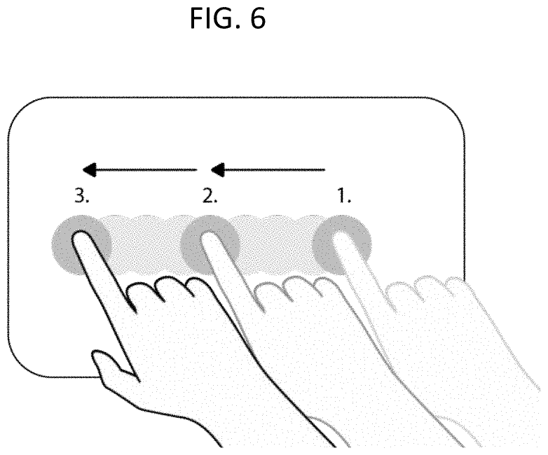

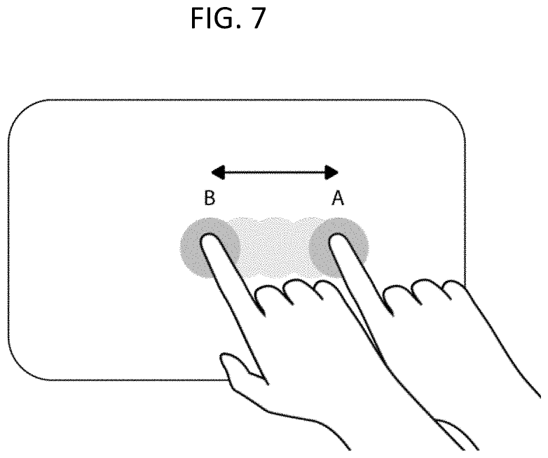

3. A static drag, e.g., as shown in FIG. 6 or 7: A touch and hold interaction combined with a sliding of the touch point to the left, right, up, down or in any other direction(s). Note that the touch point may be dragged in a first direction and then dragged in a second direction (e.g., in a direction opposite the first direction as shown in FIG. 7), and that the dragging in each distinct direction may trigger a different action;

4. Any other type of touch interaction(s) on a touch-sensitive interface such as tap gestures (single or multiple) and any combination thereof.

In other preferred implementations, a gesture may include without limitation: hand gestures, facial gestures, body gestures, voice commands and other types of gestures and any combination thereof, and the system may include recognition application(s) as necessary to recognize the gestures.

It is understood by a person of ordinary skill in the art that the scope of the system is not limited in any way by the types of gestures that may be used to trigger or otherwise control the functionalities of the system.

In one exemplary embodiment hereof, a user (e.g., a viewer of streaming media) may use one or more gestures (individually or in combination) to rewind, fast forward, pause and/or play the media, and/or to cause the media to take any other types of actions. Other aspects of the media may also be controlled using gestures, such as, without limitation, the speed of the rewinding and/or the speed of the fast forwarding.

For the purposes of this specification, the features of the system will be described in the form of various examples.

In a first example according to exemplary embodiments hereof, the viewer may be viewing streaming media on his/her media viewing device through use of the system, and may begin his/her interaction with the viewing device by performing a static hold gesture (also referred to as a touch-and-hold gesture) on the device's touchscreen. In one preferred implementation, the performance of the static hold gesture may cause the playing of the media do one of the following:

1. May cause the media to pause.

2. May cause the media to begin playing at a reduced (slower) speed.

3. May do nothing.

Note that the list of acts shown above is not all-inclusive or comprehensive and that other acts may be triggered by the static hold gesture.

The viewer may next, while continuing to hold the touch on the touchscreen of the device, begin to slide his/her finger (e.g., the finger that is performing the touch gesture) along the surface of the touchscreen. The direction of the sliding may be to the left, to the right, up, down, or in any other direction. This may also be referred to as a drag movement. It may be preferable that the movement is substantially linear but this may not be required.

The system (e.g., the media player) may detect the drag movement and may be triggered to begin rewinding the media. The rewinding may occur at a pre-defined speed or at different speeds as will be described in other sections. Note that there may preferably be a safety area of a pre-defined diameter (e.g., a few pixels) centered at the touch point that when touched by the viewer's finger, may not cause the media to rewind. This may help to ensure that a shaky static touch gesture may not inadvertently cause the rewinding to occur.

In one example according to exemplary aspects of the system, the system may detect the static touch at a position A as shown in FIG. 7, followed by a sliding (dragging) movement in a first direction (e.g., towards the left), and may begin to rewind the media at a particular speed. In this example, the system may continue to rewind the media at the particular speed regardless of how far in the first direction the user may drag his/her finger. However, upon dragging his/her finger in a second direction after the first direction (e.g., up or down), the system may be triggered to increase and/or decrease the speed of the rewind. In one example, the user may drag his/her finger to the left to begin the rewinding of the media, and then drag his/her finger up to increase the speed of the rewind, or down to reduce the speed of the rewind. Wherever the user performs this up and down movement, or just holds their finger in one place because they may be happy with the speed of the rewind function, this new position may be defined as point B (e.g., on the X axis) as shown in FIG. 7.

Note that this example is meant for demonstration purposes and that the user may drag his/her finger in any direction after the initial touch point to affect the playing and/or rewinding of the media.

In another example according to exemplary aspects of the system, the system may detect a static touch point at a position A as shown in FIG. 7, followed by a sliding (dragging) movement in a first direction (e.g., towards the left), and may begin to rewind the media at a particular speed. In this example however, the system may increase the rewind speed of the media the further that the viewer's finger may slide in the first direction away from point A. That is, the further the user slides his/her finger, the faster the rewind speed. The rate of increase in the rewind speed may be linear, logarithmic, or at any other rate.

Then, when the user may stop sliding his/her finger in the first direction, the rate of the rewind may stop increasing and may be held constant at the current rate. If the user then moves his/her finger in a second direction (e.g., in the opposite direction back towards point A), the system may decrease the rate of the rewind. If the viewer's finger reaches point A, the system may begin playing the media at the normal speed, may pause the media, may play the media at a reduced speed, or may take any other action regarding the media.

At any point, if the user lifts his/her finger and the touch-and-hold interaction stops, the content may begin to play from that point at a normal playback speed (or may take any other action).

This example may also be applied to the act of fast-forwarding the media. In one example of this, the system may detect the static touch at a position A as shown in FIG. 7, followed by a sliding (dragging) movement in a first direction (e.g., towards the right), and may begin to fast forward the media at a particular speed. In this example, the system may continue to fast forward the media at the particular speed regardless of how far in the first direction the user may drag his/her finger. However, upon dragging his/her finger in a second direction after the first direction (e.g., up or down), the system may be triggered to increase and/or decrease the speed of the fast forward. In one example, the user may drag his/her finger to the right to begin the fast forwarding of the media, and then drag his/her finger up to increase the speed of the fast forward, or down to reduce the speed of the fast forward. Wherever the user performs this up and down movement, or just holds their finger in one place because they may be happy with the speed of the rewind function, this new position may be defined as point B (e.g., on the X axis) as shown in FIG. 7.

Note that this example is meant for demonstration purposes and that the user may drag his/her finger in any direction after the initial touch point to affect the playing and/or fast forwarding of the media.

In another example according to exemplary aspects of the system, the system may detect a static touch point at a position A as shown in FIG. 7, followed by a sliding (dragging) movement in a first direction (e.g., towards the right), and may begin to fast forward the media at a particular speed. In this example however, the system may increase the fast-forward speed of the media the further that the viewer's finger may slide in the first direction away from point A. That is, the further the user slides his/her finger, the faster the fast-forward speed. The rate of increase in the fast-forward speed may be linear, logarithmic, or at any other rate.

Then, when the user may stop sliding his/her finger in the first direction, the rate of the fast forward may stop increasing and may be held constant at the current rate. If the user then moves his/her finger in a second direction (e.g., in the opposite direction back towards point A), the system may decrease the rate of the fast forward. If the viewer's finger reaches point A, the system may begin playing the media at the normal speed, may pause the media, may play the media at a reduced speed, or may take any other action regarding the media.

At any point, if the user lifts his/her finger and the touch-and-hold interaction stops, the content may begin to play from that point at a normal playback speed (or may take any other action).

Expanding on the above examples, after the user may perform an initial touch at point A followed by a drag movement in any first direction away from point A, and then reverses the direction of the drag such that his/her finger moves towards point A, one or more acts may be triggered upon the user's finger reaching, and passing, point A. In one scenario, upon the user's finger reaching and passing point A, the system may be triggered to perform a different function. For example, if the user rewinds the media by performing a touch and drag gesture in a first direction (e.g., to the left), and then reverses the drag to move in the opposite direction (e.g., to the right), once the drag may pass point A, the system may begin to fast-forward the media instead of rewinding it. In another example, if the user fast-forwards the media by performing a touch and drag gesture in a first direction (e.g., to the right), and then reverses the drag to move in the opposite direction (e.g., to the left), once the drag may pass point A, the system may begin to rewind the media instead of fast-forwarding it.

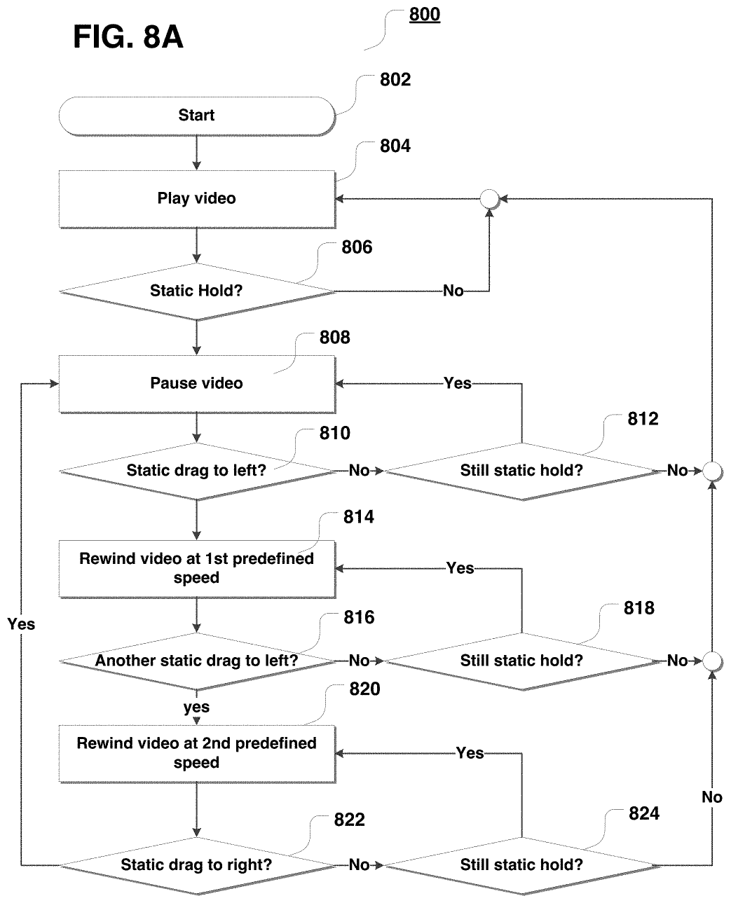

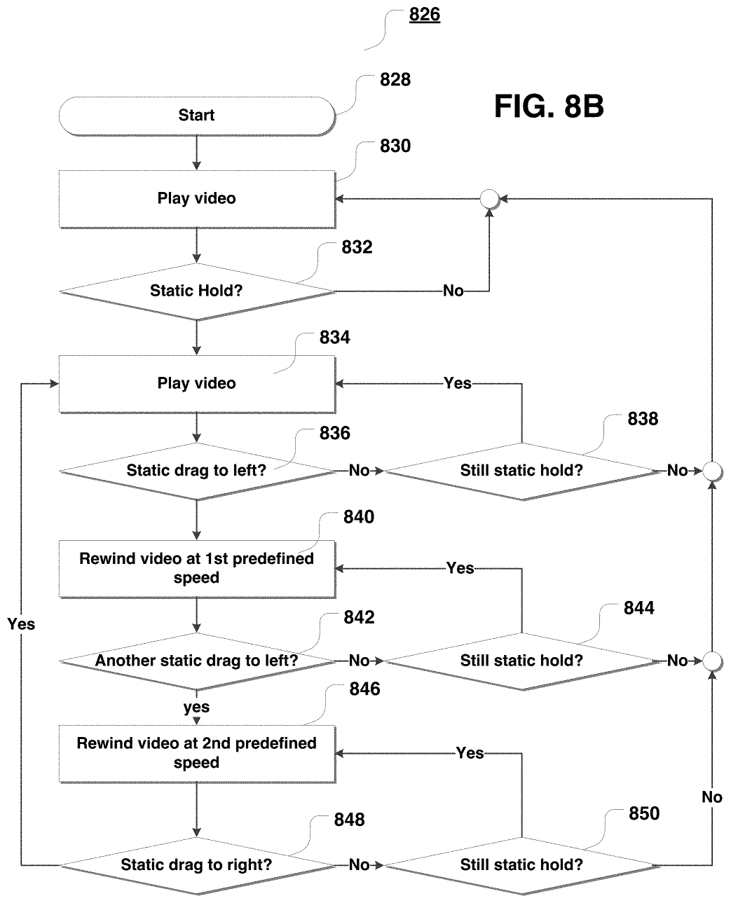

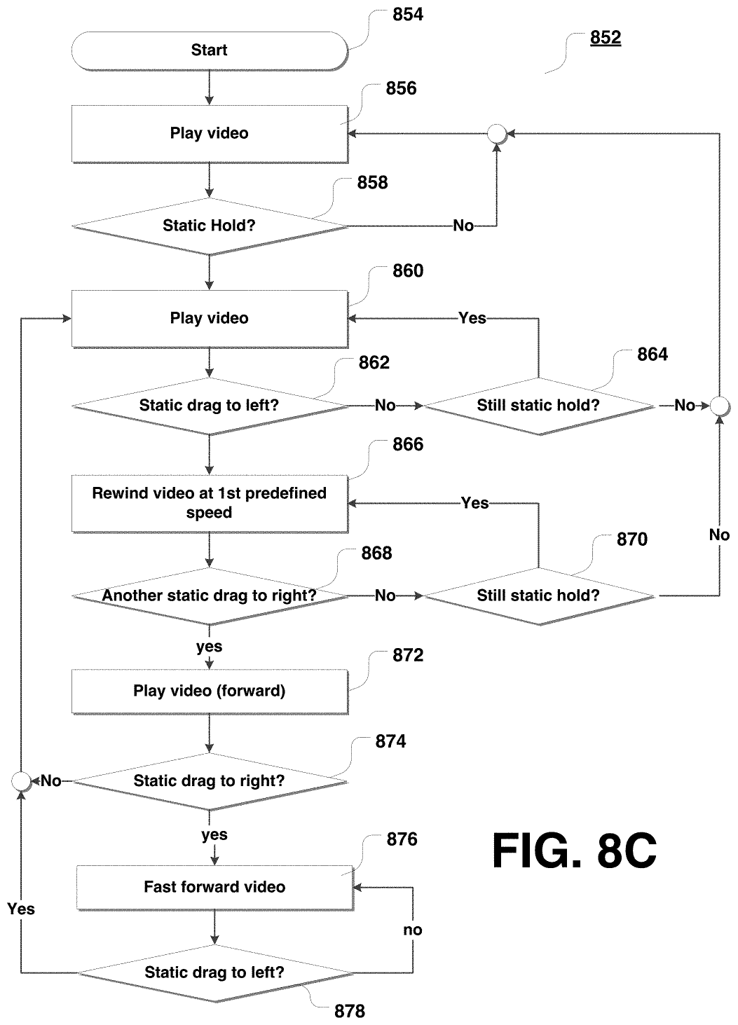

FIGS. 8A-8C are flowcharts showing exemplary operation of embodiments hereof.

In the example flow 800 of FIG. 8A, the video starts playing (at 802). While the video is playing (at 804), if a static hold is detected (at 806), the video is paused (at 808). If a static drag to the left is then detected (at 810), then the video rewinds (at 814) (i.e., plays backwards) at a first predefined speed (preferably, but not necessarily, the same speed as the playback speed). If another static drag to the left is detected (at 816), then the video plays backwards at a second predefined speed (at 820). Preferably the second predefined speed is faster (e.g., twice) than the first predefined speed. While the video is playing backwards at the second predefined speed (at 820), if a static drag to the right is detected (at 822), the video is paused (at 808).

While the video is paused (at 808), if no static drag is detected (at 810), and there is still a static hold (at 812), then the video remains paused (at 808).

While the video is rewinding (i.e., playing in reverse) at the first predefined speed (at 814), if another static drag is not detected (at 816), and there is still a static hold (at 818), then the video continues to rewind (i.e., play in reverse at the first predefined speed (at 814).

While the video is rewinding (i.e., playing in reverse) at the second predefined speed (at 820), if a static drag to the right is not detected (at 822), and there is still a static hold (at 824), then the video continues to rewind (i.e., play in reverse at the second predefined speed (at 820).

In the example flow 826 of FIG. 8B, the video starts playing (at 828). While the video is playing (at 830), if a static hold is detected (at 832), the video continues playing (at 834). If a static drag to the left is then detected (at 836), then the video rewinds (at 840) (i.e., plays backwards) at a first predefined speed (preferably, but not necessarily, the same speed as the playback speed). If another static drag to the left is detected (at 842), then the video plays backwards at a second predefined speed (at 846). Preferably the second predefined speed is faster (e.g., twice) than the first predefined speed. While the video is playing backwards at the second predefined speed (at 846), if a static drag to the right is detected (at 848), the video is played (at 834).

While the video is playing (at 834), if no static drag is detected (at 836), and there is still a static hold (at 838), then the video continues playing (at 834).

While the video is rewinding (i.e., playing in reverse) at the first predefined speed (at 840), if another static drag is not detected (at 842), and there is still a static hold (at 844), then the video continues to rewind (i.e., play in reverse at the first predefined speed (at 840).

While the video is rewinding (i.e., playing in reverse) at the second predefined speed (at 846), if a static drag to the right is not detected (at 848), and there is still a static hold (at 850), then the video continues to rewind (i.e., play in reverse at the second predefined speed (at 846).

In the example flow 852 of FIG. 8C, the video starts playing (at 854). While the video is playing (at 856), if a static hold is detected (at 858), the video continues playing (at 860). While the video is playing (at 860), if a static drag to the left is detected (at 862), then the video rewinds at a first predetermined speed (at 868) (preferably, but not necessarily, the same speed as the playback speed, e.g., real-time but backwards). While the video is rewinding at the first predetermined speed (at 868), if another static drag to the right is detected (at 868), then the video plays forward (at 872). While the video is playing forward (at 872), if a static drag to the right is detected (at 874), then the video plays at fast forward (at 876). While the video is playing at fast forward (at 876), if a static drag to the left is detected (at 878), the then the video continues to play (at 860). While the video is playing at fast forward (at 876), if no static drag to the left is detected (at 878), then the video continues to play fast forward (at 876).

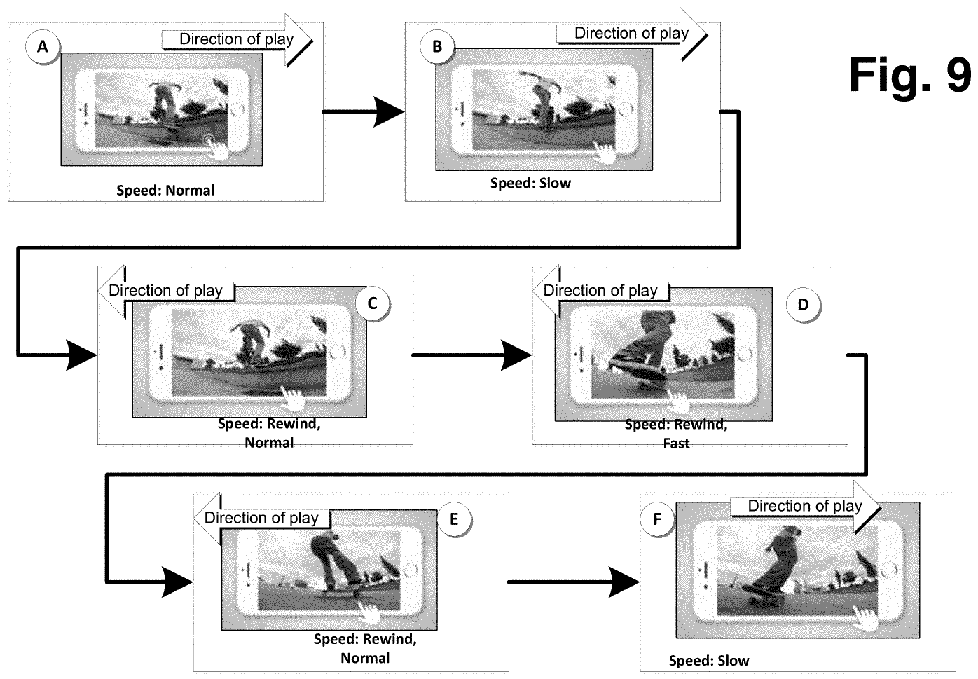

Another example is provided, with reference to FIG. 9. At A, the video is playing at normal speed and the user touches the interface (e.g., the touch screen). The application detects the touch an slows the playback (at B). While the user holds the touch, playback continues at the slow speed. While, holding the touch, if the user drags to the left, the video starts to rewind at a first predetermined speed (as shown at C). While the user continues to hold the touch on the touch interface, rewind continues at the first predetermined speed. If the user drags further to the left (as shown in D), the rewind continues at a faster speed (i.e., at a second predetermined speed, faster than the first predetermined speed). If the user continues to hold the touch on the touch interface and drags back to the right (as shown in E), the rewind returns to the first predetermined speed. If the user drags back to the right a second time (as shown in F), the video plays in the forward direction, at a slow speed (i.e., not at a normal speed). Play continues at the forward slow speed until the user releases their touch.

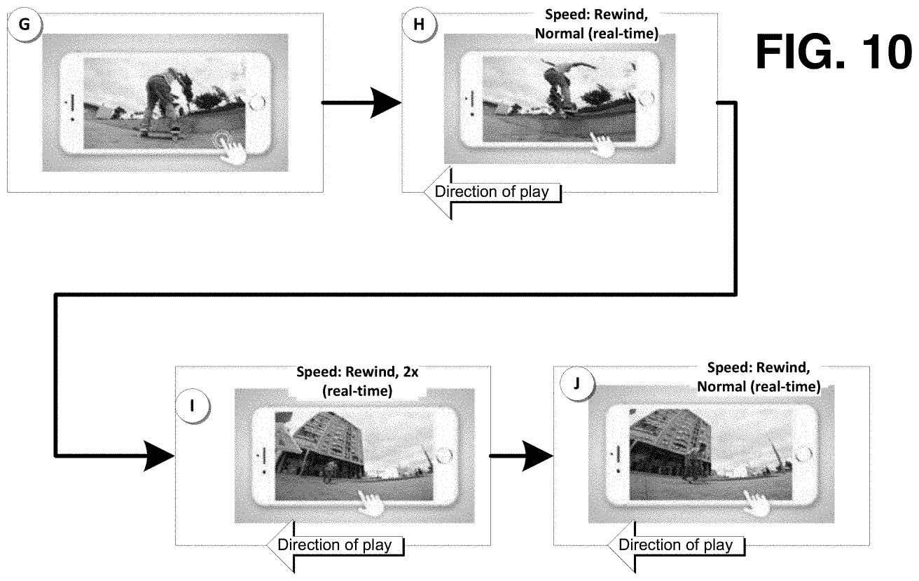

A further example is provided, with reference to the drawings in FIG. 10, where, at G, the video pauses when the user touches the touch interface. If the user then drags to the left (as shown in H), the video starts rewinding at a first rewind speed (preferably in real-time). If the user continues to hold and drags left again, the video rewinds at a second rewind speed (preferably twice the first rewind speed), as shown in I. If the user drags back to the right at any time, the video starts playing back at normal speed (e.g., as shown at J).

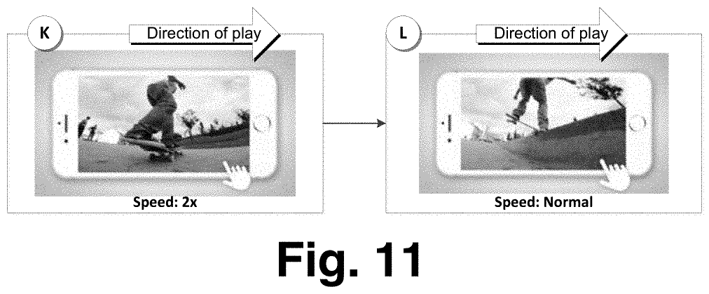

Yet another example is provided, with reference to the drawings in FIG. 11, where, at K, if the video is playing at a normal speed and the user drags to the right, the video starts to play forward at a faster speed (e.g., a twice normal speed). If the user releases their touch (as shown at L), the video returns to playback at normal speed.

It is understood by a person of ordinary skill in the art that the above examples are meant for demonstration, and that the system may be triggered to affect the streaming media in any way by the use of any type of gestures. For example, while the example above depicts the system as being triggered to rewind the media upon sensing a touch and drag gesture to the left, the system may instead be triggered to fast-forward the media upon the sensing of this gesture. In another example, while the example above depicts the system as being triggered to fast forward the media upon sensing a touch and drag gesture to the right, the system may instead be triggered to rewind the media upon the sensing this gesture. It is understood that the system may be triggered to perform any, some or all of the functions described above upon sensing touch and drag gestures performed in any direction, or combination of directions. It is also understood that the system may perform other acts not necessarily described when triggered by any type of gesture. In general, the system may sense any other type of gesture(s) and may thereby be triggered to affect the media in any way upon sensing the different types of gestures.

It is understood by a person of ordinary skill in the art, upon reading this specification, that any or all of the features of the embodiments described or otherwise may be combined in any fashion, sequence, order, combination or any combination thereof.

### Computing

The functionalities, applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed computers, special purpose computers and computing devices. One or more such computers or computing devices may be referred to as a computer system.

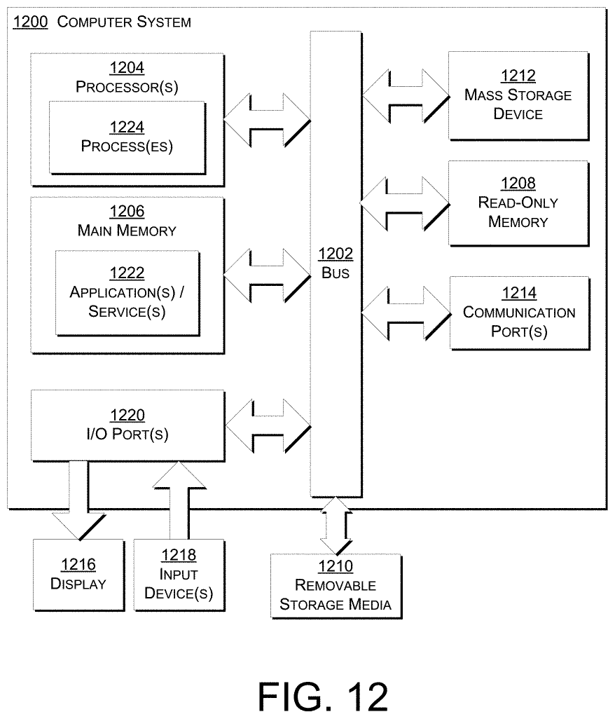

FIG. 12 is a schematic diagram of a computer system 1200 upon which embodiments of the present disclosure may be implemented and carried out.

According to the present example, the computer system 1200 includes a bus 1202 (i.e., interconnect), one or more processors 1204, a main memory 1206, read-only memory 1208, removable storage media 1210, mass storage 1212, and one or more communications ports 1214. Communication port(s) 1214 may be connected to one or more networks (not shown) by way of which the computer system 1200 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1204 can be any known processor, such as, but not limited to, an Intel® Itanium® or Itanium 2® processor(s), AMD® Opteron® or Athlon MP® processor(s), or Motorola® lines of processors, and the like. Communications port(s) 1214 can be any of an Ethernet port, a Gigabit port using copper or fiber, or a USB port, and the like. Communications port(s) 1214 may be chosen depending on a network such as a Local Area Network (LAN), a Wide Area Network (WAN), or any network to which the computer system 1200 connects. The computer system 1200 may be in communication with peripheral devices (e.g., display screen 1216, input device(s) 1218) via Input/Output (I/O) port 1220.

Main memory 1206 can be Random Access Memory (RAM), or any other dynamic storage device(s) commonly known in the art. Read-only memory (ROM) 1208 can be any static storage device(s) such as Programmable Read-Only Memory (PROM) chips for storing static information such as instructions for processor(s) 1204. Mass storage 1212 can be used to store information and instructions. For example, hard disk drives, an optical disc, an array of disks such as Redundant Array of Independent Disks (RAID), or any other mass storage devices may be used.

Bus 1202 communicatively couples processor(s) 1204 with the other memory, storage and communications blocks. Bus 1202 can be a PCI/PCI-X, SCSI, a Universal Serial Bus (USB) based system bus (or other) depending on the storage devices used, and the like. Removable storage media 1210 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 1206 is encoded with application(s) 1222 that support(s) the functionality as discussed herein (the application(s) 1222 may be an application(s) that provides some or all of the functionality of the services/mechanisms described herein. Application(s) 1222 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 1204 accesses main memory 1206 via the use of bus 1202 in order to launch, run, execute, interpret or otherwise perform the logic instructions of the application(s) 1222. Execution of application(s) 1222 produces processing functionality of the service related to the application(s). In other words, the process(es) represent one or more portions of the application(s) 1222 performing within or upon the processor(s) 1204 in the computer system 1200.

It should be noted that, in addition to the process(es) that carries (carry) out operations as discussed herein, other embodiments herein include the application 1222 itself (i.e., the un-executed or non-performing logic instructions and/or data). The application 1222 may be stored on a computer readable medium (e.g., a repository) such as a disk or in an optical medium. According to other embodiments, the application 1222 can also be stored in a memory type system such as in firmware, read only memory (ROM), or, as in this example, as executable code within the main memory 1206 (e.g., within Random Access Memory or RAM). For example, application(s) 1222 may also be stored in removable storage media 1210, read-only memory 1208, and/or mass storage device 1212.

Those of ordinary skill in the art will understand that the computer system 1200 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

### Conclusion

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

Thus is provided an expandable and flexible shirt elbow section and a shirt with the same.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A method of controlling playback of video content on video player on an electronic computing device, the method comprising:
playing a video content or playing the video content on a display associated with the device when a user selects the content;
detecting a user interaction on a touch-sensitive interface, wherein said user interaction comprises one or more of: a static hold interaction and/or a drag interaction;
in response to detection of said user interaction, the video player rewinding or fast-forwarding a video content; and
in response to detecting cessation of the user interaction, the video player playing back the video content at normal speed.

2. The method of claim 1, wherein the touch-sensitive interface is on the display and/or on the device.

3. The method of claim 1, wherein the touch-sensitive interface is apart from the device.

4. The method of claim 1,
wherein the user interaction detected comprises a static hold interaction on the touch-sensitive interface, the method further comprising:
in response to detection of the static hold interaction, the video player (i) continuing to play the video content, or (ii) pausing play of the video content, or (iii) playing the video content at a slower speed.

5. The method of claim 1, wherein the user interaction detected comprises a combined static hold interaction and drag movement interaction on the touch-sensitive interface, the method further comprising:
in response to detection of the combined static hold interaction and drag movement interaction on the touch-sensitive interface, the video player rewinding the video content.

6. The method of claim 5, where a rewind speed increases based on how far and/or how many times the user drags the static hold of the touch in a first direction.

7. The method of claim 5, where a rewind speed varies in response to a distance and/or number times of the drag movement.

8. The method of claim 6, where the rewind speed decreases as the user drags the static hold of the touch in a direction opposite the first direction.

9. The method of claim 5, where a rewind speed changes as the user drags the static hold of the touch up or down on the touch-sensitive interface.

10. The method of claim 5, where the playback pauses or returns to playback or to slower playback once the user drags the static hold back to a starting point of the static hold interaction.

11. The method of claim 5, where the playback pauses or returns to playback or slower playback once the user drags the static hold in an opposite direction.

12. The method of claim 11, wherein the player starts fast-forwarding the video content once the user drags the static hold in the opposite direction again.

13. The method of claim 1, where the interaction detected comprises a static hold with a drag movement,
wherein a first direction corresponds to a rewind direction and a second direction, substantially opposite said first direction, corresponds to a fast-forward direction,
the method further comprising:
in response to detection of the static hold combined with a drag movement in the fast-forward direction, the video player fast-forwarding the video content.

14. The method of claim 12, where a fast-forward speed increases the further the user drags and/or a number of times the user drags the static hold of the touch to a fast-forward direction.

15. The method of claim 12, where the fast-forward speed decreases as the user drags the static hold of the touch to the opposite direction.

16. The method of claim 12, where the fast-forward speed changes as the user drags the static hold of the touch up or down.

17. The method of claim 12, where the playback pauses again or returns to slower playback once the user drags the static hold back to a starting point of initial static hold interaction.

18. The method of claim 12, where the playback pauses again or returns to playback or slower playback once the user drags the static hold in the opposite direction.

19. The method of claim 18, where the player starts rewinding the video content as the user drags the static hold in the opposite direction again.

20. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of claim 1.

21. A system comprising:
(a) hardware including memory and at least one processor, and
(b) a service running on said hardware, wherein said service is configured to:
perform the method of claim 1.
